(19) United States
(12) Patent Application Publication
(10) Pub. No.: US 2019/0264670 A1
(43) Pub. Date: Aug. 29, 2019

(54) THERMAL PUMP FOR FLUID NEAR A PHASE TRANSITION

(71) Applicant: Waters Technologies Corporation, Milford, MA (US)

(72) Inventors: Joshua A. Shreve, Acton, MA (US); Christopher Seith, Franklin, MA (US)

(21) Appl. No.: 16/263,013

(22) Filed: Jan. 31, 2019

Related U.S. Application Data
(60) Provisional application No. 62/635,083, filed on Feb. 26, 2018.

(51) Int. Cl. F04B 15/08; B01D 15/40; G01N 30/32

(52) U.S. Cl. CPC F04B 15/08; B01D 15/40; F04B 2015/0818; G01N 2030/326; G01N 30/32

(57) ABSTRACT

Described is an apparatus for providing a fluid at an increased pressure. The apparatus has a range of applications including use with carbon dioxide-based chromatography systems to achieve accurate flow rate control for a carbon dioxide pump. The apparatus includes a thermally-controlled chamber, chamber inlet and outlet check valves, and a temperature controller to control a temperature of fluid inside the chamber. The apparatus also includes a capacitance chamber in fluidic communication with the outlet check valve. A flow of gas passes into the chamber through the inlet check valve when a fluid pressure inside the chamber is less than an inlet fluid pressure and out from the chamber through the outlet check valve when the fluid pressure inside the chamber is greater than an outlet fluid pressure. Thermal control of the chamber allows accurate control of the gas flow into and out from the chamber.

### RELATED APPLICATION(S)

This application claims the benefit of and priority to U.S. provisional application No. 62/635,083, filed Feb. 26, 2018, titled “Thermal Pump for Fluid Near a Phase Transition” the entirety of which is incorporated by reference herein.

### FIELD OF THE INVENTION

The invention relates generally the pumping of a fluid near a phase transition. More particularly, the invention relates to a method and apparatus for pumping of such a fluid as a mobile phase for a chromatography system.

### BACKGROUND

Supercritical fluid chromatography (SFC) systems typically use carbon dioxide pumps that require cooling of the inlet carbon dioxide flow and the pump head so that the pump can provide a flow of carbon dioxide at an accurately controlled flow rate. The flow of carbon dioxide is typically in a supercritical state at the column; however, in some circumstances the mobile phase may be in a near-supercritical state when the mobile phase includes both carbon dioxide and a co-solvent such as methanol, ethanol, isopropyl alcohol or acetonitrile.

Saturated carbon dioxide supply tanks are often used to supply carbon dioxide to analytical SFC instruments and convergence chromatography instruments. A saturated supply tank is subject to environmental conditions and generally requires condensing the carbon dioxide gas that is dispensed from the supply tank to a liquid near the carbon dioxide pump. A tank heater can be used to increase the pressure of the gas drawn from the supply tank; however, the ability to accurately control the temperature and delivery pressure of the dispensed gas is limited. Thus the delivery pressure of the carbon dioxide received at the pump inlet can vary, resulting in a degradation of pump performance.

### SUMMARY

Embodiments of the present disclosure include apparatus and methods for providing a fluid at an increased pressure.

In one example, an apparatus for providing a fluid at an increase pressure includes a thermally-controlled chamber, an inlet check valve, an outlet check valve and a temperature controller. The thermally-controlled chamber has an inlet, an outlet and an enclosed volume. The inlet check valve is disposed at the inlet and is configured to pass a flow of gas into the thermally-controlled chamber when a pressure of the enclosed volume is less than an inlet fluid pressure. The outlet check valve is disposed at the outlet and is configured to pass a flow of gas out from the thermally-controlled chamber when the fluid pressure of the enclosed volume is greater than an outlet fluid pressure. The temperature controller is in communication with the thermally-controlled chamber.

The apparatus may further include a capacitance chamber in fluidic communication with the outlet check valve and configured to hold a volume of the gas at a pressure that is greater than the inlet fluid pressure.

The apparatus may be configured to control a temperature of the enclosed volume in a temperature range extending from a first temperature that is below an ambient temperature and a second temperature that is greater than the ambient temperature.

The apparatus may further include a temperature controller that is in communication with the thermally-controlled chamber and configured to control a temperature of the enclosed volume. The temperature controller may be configured to change the temperature of the enclosed volume between a minimum temperature at which the inlet check valve passes the flow of gas into the thermally-controlled chamber and a maximum temperature at which the outlet check valve passes the flow of gas out from the thermally-controlled chamber.

The thermally-controlled chamber may include tubing and may further include a thermally-conductive plate in thermal communication with the tubing. The thermally-conductive plate may be in communication with a cooling system and/or a heating system. The cooling system may be a thermo-electric cooler and/or a refrigerant system. The heating system may include at least one resistive heating element disposed on at least one surface of the thermally-conductive plate.

In another example, a method for providing a fluid at an increased pressure includes decreasing a temperature of a chamber so that a pressure of a fluid inside the chamber is less than an inlet fluid pressure to thereby generate a flow of a gas into the chamber and decreasing the temperature of the chamber so that at least a portion of the gas inside the chamber condenses into a liquid. The method further includes increasing the temperature of the chamber so that the pressure of the fluid inside the chamber increases to greater than the inlet fluid pressure to stop the flow of the gas into the chamber and increasing the temperature of the enclosed fluid so that the pressure of the fluid inside the chamber increases to greater than an outlet fluid pressure to thereby generate a flow of fluid from the chamber that is greater than the inlet fluid pressure.

The method may further include controlling the temperature of the chamber so that the pressure of the flow of fluid from the chamber is substantially constant.

The flow of fluid from the chamber may be delivered to a capacitance volume.

The method may further include providing the flow of fluid from the chamber to an inlet of a pump, cooling the flow of fluid from the chamber so that the flow of fluid at the inlet of the pump is a flow of a liquid, and generating a flow of fluid at an outlet of the pump at a pressure that is greater than the pressure of the flow of liquid at the inlet of the pump. The cooling of the flow of fluid may include ambient cooling. The flow of fluid at the outlet of the pump may be a flow of a supercritical fluid.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 is a block diagram of an example of a carbon dioxide based chromatography system for preparative scale chromatography applications.

FIG. 2 is a block diagram of an embodiment of an apparatus for providing a fluid at an increased pressure.

FIG. 3 is a flowchart representation of one embodiment of a method for providing a fluid at an increased pressure.

FIG. 4 is a block diagram of another embodiment of an apparatus for providing a fluid at an increased pressure.

FIG. 5 is a graphical representation showing one example of how the temperature can be controlled for each chamber of the apparatus shown in FIG. 4.

FIG. 6 is a block diagram of another embodiment of an apparatus for providing a fluid at an increased pressure.

FIG. 7A and FIG. 7B are a top down view and a cross-sectional side view, respectively, of a simplified illustration of one embodiment of a thermally-controlled chamber for use in an apparatus for providing a fluid at an increased pressure.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to embodiments thereof as shown in the accompanying drawings. It is to be understood that such terms like top, bottom, below, upper, lower, horizontal and vertical are relative terms used for purposes of simplifying the description of features as shown in the figures, and are not used to impose any limitation on the structure or use of any structures or methods described herein. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure.

Reference is made herein to carbon dioxide-based chromatography systems although it will be recognized that the principles described with respect to such systems are applicable to chromatography systems that may utilize other types of fluids for a mobile phase. In some embodiments the systems are configured to operate with the fluid, and optionally one or more co-solvent fluids, in a gaseous state at ambient or room temperature and pressure, and with the fluid in a liquid, near-supercritical or supercritical state in at least one location within the chromatography system. For example, if the solvent is pure carbon dioxide, the fluid may be in a supercritical state somewhere within the chromatography system; however, as a co-solvent such as methanol is added to the solvent, the solvent mixture may be subcritical at some times and at one or more locations in the system. A fluid which is near-supercritical or supercritical while flowing through the chromatographic column may be liquid or gaseous at other locations within the system.

As used herein, “chamber” means any structure defining an enclosed volume or space without limitation on the shape of the structure. For example, the chamber may be a length of tubing. “Substantially constant pressure” means that small variations in pressure may occur; however, no noticeable or appreciable effect of operation occurs as a result of such variations. For example, substantially constant pressure of a fluid supplied to a pump means that the performance of the pump (e.g., pump flow rate) is not affected or is negligibly affected by the variations in pressure.

In brief overview, embodiments of an apparatus and a method for providing a fluid at an increased pressure advantageously utilize the phase change of the fluid to pump the fluid. The apparatus includes a thermally-controlled chamber, an inlet check valve at a chamber inlet, an outlet check valve at a chamber outlet, and a capacitance chamber in fluidic communication with the outlet check valve. A flow of gas passes into the chamber through the inlet check valve when a fluid pressure inside the chamber is less than an inlet fluid pressure. A flow of gas exits the chamber through the outlet check valve when the fluid pressure inside the chamber is greater than an outlet fluid pressure. Thermal control of the chamber allows control of the gas flow into and out from the chamber. In effect, the apparatus acts as a booster pump for the chromatography system and allows the chromatography pump to operate in a high flow and high pressure regime to allow for consistent delivery and performance by the chromatography pump, especially under cooler ambient temperatures.

Advantageously, the apparatus does not require any moving parts, resulting in high reliability and long lifetime. The apparatus can provide a denser and less compressible fluid to a chromatography system pump. Consequently, the apparatus can eliminate the need for cooling at the pump head and associated power requirements although, in some embodiments, direct cooling of the pump head may be independently provided to reduce the transfer of heat from the pump head to the fluid.

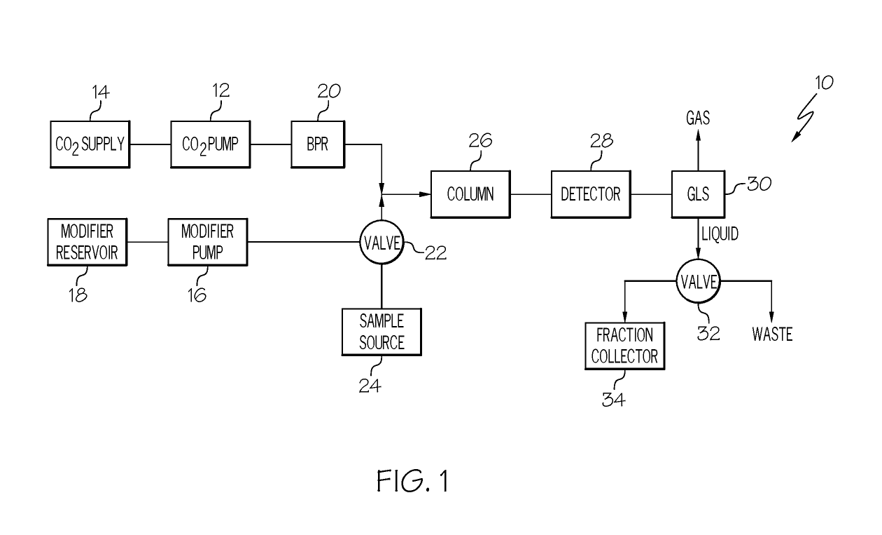

Referring to FIG. 1, a carbon dioxide based chromatography system 10 for preparative scale chromatography applications includes a carbon dioxide pump 12 that draws a flow of carbon dioxide from a carbon dioxide source 14. A modifier pump 16 draws a flow of a modifier (e.g., methanol) from a modifier reservoir 18. An automated back pressure regulator 20 receives the high pressure flow of carbon dioxide from the pump 12. An injection valve 22 is used to inject a chromatographic sample from a sample source 24 into the carbon dioxide system flow. In the illustrated system the modifier is also introduced to the system flow through the injection valve 22. The system flow passes through a chromatographic column 26 and detector 28 before entering a gas-liquid separator (GLS) 30 where carbon dioxide gas exits from one outlet and liquid (e.g. methanol and any sample analytes) exit from a different outlet. A valve 32 directs the liquid flow to a fraction collector 34 or a waste channel. The fraction collector 34 typically operates at a substantially reduced pressure relative to the pressure used in the chromatography system 10. For example, the chromatography system flow may be pressurized between 3,000 psi and 4,000 psi (20 MPa and 28 MPa) and the fraction collector 34 may be at atmospheric pressure.

In some implementations, the carbon dioxide supply 14 is a “house system” where the carbon dioxide is typically delivered above equilibrium pressure by a booster pump. However, in other implementations, the carbon dioxide supply 14 includes one or more local carbon dioxide tanks and the carbon dioxide supplied to the carbon dioxide pump 12 may be in a gas state. In such systems, a chilling system is used so that the gas condenses before the pump inlet to enable satisfactory pump performance and accurate high pressure flow rates.

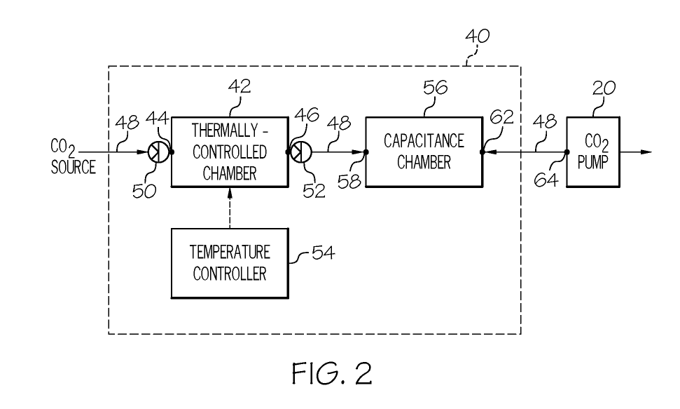

FIG. 2 is a block diagram of an embodiment of an apparatus 40 for providing a fluid at an increased pressure. The apparatus 40 can reduce or eliminate any need for a chilling system for cooling the flow at the inlet of the carbon dioxide pump 20. The apparatus 40 includes a thermally-controlled chamber 42 having an enclosed volume, an inlet 44 and an outlet 46. An inlet check valve 50 is disposed in a fluidic path 48 near to or at the inlet 44 and an outlet check valve 52 is disposed in the fluidic path 48 near to or at the outlet 46. The fluidic path 48 may include a tubing compatible with the operating pressure and temperature ranges, and is resistant to the fluids being pressurized. For example, the tubing may be stainless steel tubing or MP35N® tubing. The inlet check valve 50 is configured to pass a flow of fluid through the inlet 44 and into the enclosed volume of the chamber 42 when a fluid pressure of the enclosed volume is less than an inlet fluid pressure. The outlet check valve 52 is configured to pass a flow of the fluid out from the enclosed volume of the chamber 42 and through the outlet 46 when the fluid pressure of the enclosed volume is greater than an outlet fluid pressure. The check valves 50 and 52 prevent the flow of fluid in a reverse direction (right to left in the figure). The apparatus 40 also includes a temperature controller 54 in communication with the thermally-controlled chamber 42 and a capacitance chamber 56 having an inlet 58 in fluidic communication with the outlet 46 of the chamber 42 through the outlet check valve 52. The capacitance chamber 56 holds a volume of the fluid at a pressure that is greater than the inlet fluid pressure.

A carbon dioxide pump 20 is in fluidic communication with the apparatus 40 by way of a portion of the fluidic path 48 that extends from an outlet 62 of the capacitance chamber 56 to a pump inlet 64. Optionally, a condenser or cooling module can be used between the apparatus 40 and the pump inlet 64; however, the apparatus 40 can eliminate the need for such a condenser in many applications, as described below, as the fluid may cool and condense downstream in the tubing used to deliver the higher pressure fluid to the pump 20.

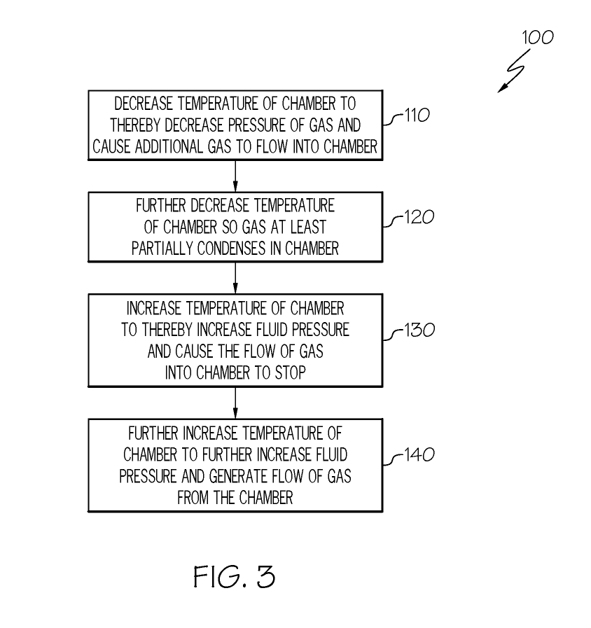

Reference is also made to FIG. 3 which is a flowchart representation of an embodiment of a method 100 for providing a fluid at an increased pressure. A flow of carbon dioxide from a carbon dioxide source is received at the inlet check valve 50. For example, the carbon dioxide may be source from a tank disposed near to the chromatography system. The flow of carbon dioxide supplied to the apparatus 40 is near or at equilibrium. Initially, the carbon dioxide flows primarily as a gas from the inlet check valve 50 to the pump inlet 64 until carbon dioxide is present at equal pressure throughout the apparatus 40 due to operation of the check valves 50 and 52.

The method 100 includes decreasing (110) the temperature of the carbon dioxide inside the thermally-controlled chamber 42. As a result, the internal pressure (i.e., the pressure of the fluid inside the chamber 42) decreases to less than an inlet fluid pressure (i.e., the pressure on the upstream side of the inlet check valve 50) so that carbon dioxide gas flows through the inlet check valve 50 and is received by the chamber 42. As the temperature of the chamber 42 is further decreased (120), at least a portion of the carbon dioxide gas condenses into a liquid that accumulates inside the chamber 42. Subsequently, the temperature of the chamber 42 is increased (130) and the pressure of the carbon dioxide in the chamber 42 increases to greater than the inlet fluid pressure to stop the flow of the carbon dioxide gas into the chamber 42. During the period of increasing temperature, at least a portion of the liquid carbon dioxide transitions to a gas state. As further heating (140) of the chamber 42 occurs, the internal pressure continues to increase until it is greater than the outlet fluid pressure (i.e., the pressure on the downstream side of the outlet check valve 52) so that the chamber 42 provides a flow of high pressure carbon dioxide gas through the outlet check valve 52.

The maximum temperature of the chamber 42 is selected to be sufficiently high so that the outlet fluid pressure is substantially greater than the inlet fluid pressure. Consequently, the pressure of the gas stored in the capacitance chamber 56 is therefore substantially greater than the pressure of the gas provided by the carbon dioxide source. The temperature cycle defined by each decreasing and then increasing of the temperature of the chamber 42 according to steps 110 through 140 can be repeated so that the capacitance chamber 56 is maintained in a substantially filled condition and the carbon dioxide received at the pump 20 is at a substantially constant pressure that is greater than the pressure of the gas delivered by the carbon dioxide source. In some embodiments, the temperature cycling occurs between a minimum temperature that is less than an ambient temperature and a maximum temperature that is greater than the ambient temperature.

As described above, if the fluid received at the pump 20 is gas, the ability to accurately control the pump flow rate is compromised. Advantageously, the higher pressure fluid provided to the pump inlet 34 by the apparatus 40 can be maintained in a substantially liquid state as the gas condenses along the fluid path 48 before reaching the pump inlet 34, allowing the pump flow rate to be accurately controlled.

By way of examples, the apparatus 40 may be used to increase a carbon dioxide supply pressure which may be less than 500 psi (3.4 MPa) to greater than 900 psi (6.2 MPa), dependent in part on temperature, to an increased pressure of less than 850 psi (5.9 MPa) to greater than 1,000 psi (6.9 MPa).

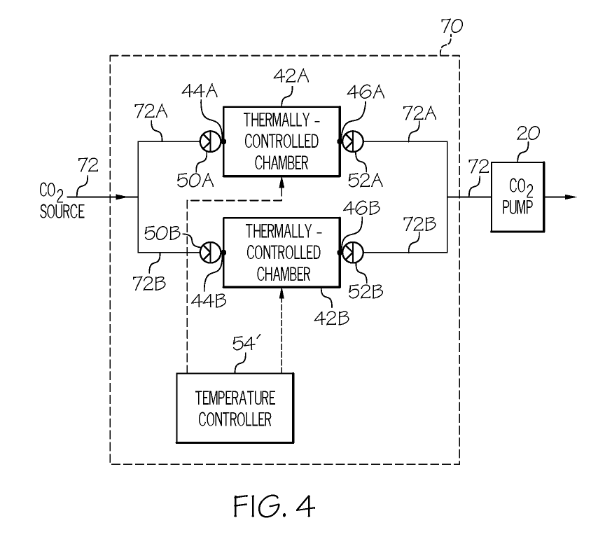

FIG. 4 shows an alternative embodiment of an apparatus 70 for providing a fluid at an increased pressure in which a capacitance chamber is not present. The reference numbers for various features terminate with the letter “A” or “B” according to the particular path for the component. The apparatus 70 includes a single fluidic path 72 that receives carbon dioxide from a carbon dioxide source. The fluidic path 72 separates into two path branches 72A and 72B with each branch having features similar to those described above for the single path configuration of FIG. 2. The temperature controller 54′ communicates with both chambers 42A and 42B, and provides independent temperature control.

In operation, one of the chambers 42A or 42B performs the function of a capacitance chamber while the other chamber 42B or 42A is thermally modulated as described above. A continuous flow of high pressure fluid can be provided to the pump 20 by alternating the thermal modulation between the two chambers 42A and 42B and by alternating the role of a capacitance chamber between the two paths 72A and 72B. In one embodiment, the temperature controller 54′ issues temperature commands for the two channels that are 180° different in phase.

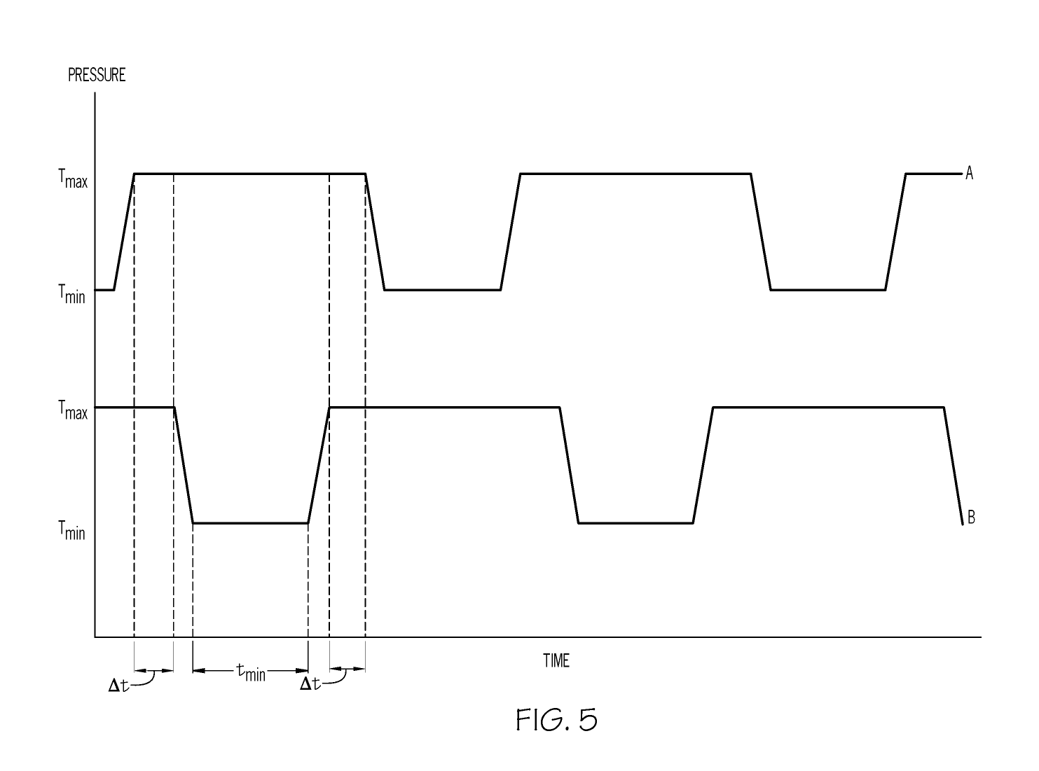

FIG. 5 shows one example of how the temperature can be controlled for each chamber 42. Temperature waveforms A and B correspond to the thermally-controlled chambers 42A and 42B, respectively, and are displaced vertically from each other for comparison. The maximum and minimum temperatures Tₘₐₓ and Tₘᵢₙ for each waveform are the same. The temperature of the first chamber 42A is ramped down to a minimum temperature Tₘᵢₙ during which carbon dioxide gas flows into that chamber 42A and at least some of the gas condenses to liquid. After a time tₘᵢₙ, the temperature of the chamber 42A is increased to a maximum temperature Tₘₐₓ so that the enclosed fluid can be increased to the higher pressure. The second chamber 42B has a temperature that is controlled in a complementary manner, that is, its waveform is out of phase with the first waveform by 180°. Preferably, the maximum temperature Tₘₐₓ for each chamber 42 is maintained at least until the other chamber 42 reaches the maximum temperature Tₘₐₓ to ensure no substantial disruption to the pressure at the carbon dioxide pump 20. Thus there are periods Δt during each temperature cycle when both chambers 42 are near or at the maximum temperature Tmax.

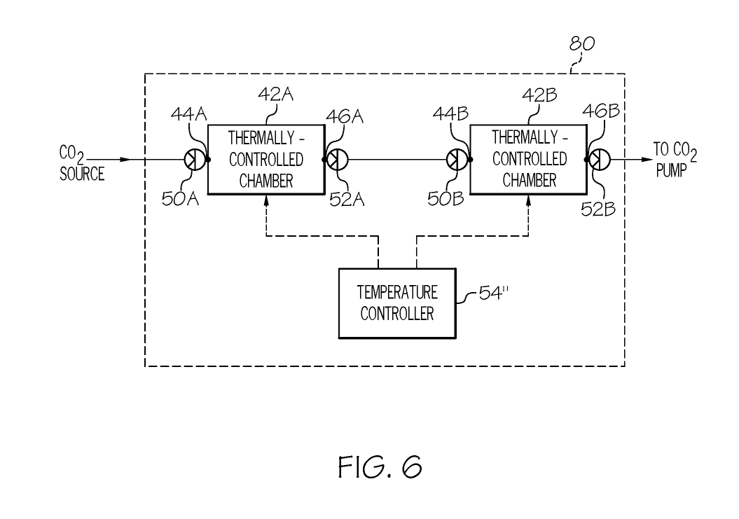

FIG. 6 is a block diagram showing an embodiment of an apparatus 80 for providing a fluid at an increased pressure in which like reference numbers refer to similar features in the embodiments described above. The illustrated embodiment includes a serial configuration of thermally-controlled chambers 42A and 42B with a temperature controller 54″ that provides independent and concurrent control of both chambers 42. In this embodiment, the second chamber 42B provides an additional pressure increase; however, it should be recognized that there may be no phase change occurring if the fluid provided to the second stage is in a supercritical state.

Thus the two stage configuration of FIG. 6 enables a higher pressure flow from the outlet check valve 52B of the second chamber 42B than can be achieved with a single stage arrangement. The temperature controller 54″ may control the temperature of the second chamber 42B using a different temperature modulation than for the first chamber 42A. For example, the minimum and maximum temperatures Tₘᵢₙ and Tₘₐₓ of the second chamber 42A may be greater than those used to control the first chamber 42A.

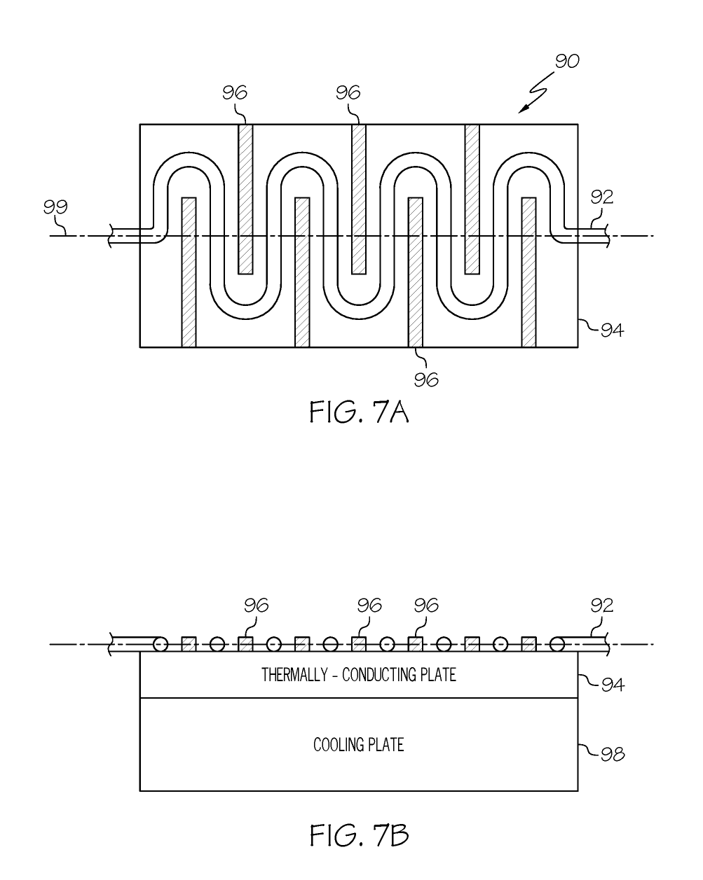

FIG. 7A and FIG. 7B are a top down view illustration and a cross-sectional side view illustration, respectively, of one embodiment of a thermally-controlled chamber 90 for use in an apparatus for providing a fluid at an increased pressure. The chamber 90 includes a length of stainless steel tubing 92 that is fixed to a top side of a thermally conductive plate 94. The particular dimensions of the tubing 92 and plate 94 are chosen to accommodate the desired flow, pressure and operating temperature of the fluid. By way of a non-limiting numerical example, the tubing 92 may have an inner diameter of 0.062 in. (1.6 mm) and an outer diameter of 0.125 in. (3.2 mm), and the plate may have a length of about 8.0 in. (200 mm) and a width of about 4.0 in. (100 mm). The plate material may be aluminum, copper or another material having sufficient thermal conductivity to allow efficient and rapid control of the plate and tubing temperature. The tubing 92 may be secured to the plate 94 using a thermally-conductive epoxy. Alternatively, the tubing 92 may be cast in the plate 94 or brazed or soldered to the plate 94 to provide high thermal conductivity. The tubing 92 is configured to have a serpentine path to increase its length in contact with the plate 94 and thereby increase heat transfer between the tubing 92 and plate 94. Couplings may be provided at ends of the tubing 92 to allow the chamber 90 to be installed inline upstream from the carbon dioxide pump. The thermally conductive plate 94 may be an aluminum plate dimensioned to have a low thermal mass so that its temperature can be rapidly controlled. Electrical resistance heater strips 96 are disposed along the upper surface of the plate 94 between the bends of the serpentine path. A cooling plate 98 is fixed to the bottom side of the thermally conductive plate 94. For example, the cooling plate 98 may be mechanically attached to the thermally conductive plate 94 with a layer of thermal grease or thermal epoxy disposed between the two plates. The particular dimensions of the cooling plate 98 and the means used to cool and heat the plate 98 are generally dependent on the enclosed volume of the thermally-controlled chamber 90, the thermal mass of the thermally-conductive plate 94 and the required rate of heating and cooling.

In one example suitable for some carbon dioxide-based systems, the cooling plate 98 is part of a thermo-electric cooler (e.g., a Peltier device). In an alternative example suitable for some preparative chromatography systems, the cooling plate 98 is cooled by a flow of a coolant or refrigerant supplied through one or more internal coolant channels and/or coolant channels disposed on a side of the cooling plate 98 that is opposite to the thermally conductive plate 94. Such a configuration typically uses a compressor and heat exchanger, and the ability to quickly modulate the temperature can be limited, therefore the system may be operated for constant refrigerant flow. In this configuration, thermal modulation is achieved through control of heating elements that supply sufficient heat to overcome the constant cooling provided by the refrigerant flow. In another alternative embodiment suitable for high volumes of fluid and short thermal cycling times, the chamber 90 includes a series of cold fingers passing refrigerated liquid and one or more high power hot plates in contact with the thermally conductive plate 94.

Although the enclosed volume for the chamber 90 of FIG. 7A is defined by the inner diameter of the tubing 92 and the length of the serpentine path, in other embodiments the shape of the enclosed volume can vary as long as the volume of fluid within the chamber can be rapidly cooled and heated. Moreover, it will be recognized that other arrangements of serial and/or parallel thermally controlled chambers are contemplated to achieve greater flow rates and/or higher pressures.

In various embodiments described above, the fluid is carbon dioxide. It will be appreciated that in other embodiments other fluids may be used and that the phase change temperatures and pressures will vary according to the particular fluid. By way of non-limiting alternative examples, the fluid can be a refrigerant such as ammonia or may be another fluid having a phase transition at room temperature and elevated pressure. Conversely, the operating temperature may be elevated with respect to room temperature for use at lower pressures. The temperature control of the thermally controlled chamber includes cycling the cooling and heating of the contained fluid so that the fluid has a cyclic transition between a state in which it is primarily a liquid and a state in which it is primarily a gas.

While the invention has been shown and described with reference to specific preferred embodiments, it should be understood by those skilled in the art that various changes in form and detail may be made therein without departing from the spirit and scope of the invention as defined by the following claims.

1. A method for providing a fluid at an increased pressure, the method comprising:
decreasing a temperature of a chamber so that a pressure of a fluid inside the chamber is less than an inlet fluid pressure to thereby generate a flow of a gas into the chamber;
decreasing the temperature of the chamber so that at least a portion of the gas inside the chamber condenses into a liquid;
increasing the temperature of the chamber so that the pressure of the fluid inside the chamber increases to greater than the inlet fluid pressure to stop the flow of the gas into the chamber; and
increasing the temperature of the enclosed fluid so that the pressure of the fluid inside the chamber increases to greater than an outlet fluid pressure to thereby generate a flow of fluid from the chamber that is greater than the inlet fluid pressure.

2. The method of claim 1 further comprising controlling the temperature of the chamber so that the pressure of the flow of fluid from the chamber is substantially constant.

3. The method of claim 1 wherein the flow of fluid from the chamber is delivered to a capacitance volume.

4. The method of claim 1 further comprising:
providing the flow of fluid from the chamber to an inlet of a pump;
cooling the flow of fluid from the chamber so that the flow of fluid at the inlet of the pump is a flow of a liquid; and
generating a flow of fluid at an outlet of the pump at a pressure that is greater than the pressure of the flow of liquid at the inlet of the pump.

5. The method of claim 4 wherein the cooling includes ambient cooling of the flow of fluid.

6. The method of claim 4 wherein the flow of fluid at the outlet of the pump is a flow of a supercritical fluid.

7. An apparatus for providing a fluid at an increased pressure, comprising:
a thermally-controlled chamber having an inlet, an outlet and an enclosed volume;
an inlet check valve disposed at the inlet and configured to pass a flow of gas into the thermally-controlled chamber when a pressure of the enclosed volume is less than an inlet fluid pressure;
an outlet check valve disposed at the outlet and configured to pass a flow of gas out from the thermally-controlled chamber when the fluid pressure of the enclosed volume is greater than an outlet fluid pressure; and
a temperature controller in communication with the thermally-controlled chamber.

8. The apparatus of claim 7 further comprising a capacitance chamber in fluidic communication with the outlet check valve and configured to hold a volume of the gas at a pressure that is greater than the inlet fluid pressure.

9. The apparatus of claim 7 wherein the thermally-controlled chamber comprises tubing.

10. The apparatus of claim 7 wherein the thermally-controlled chamber is configured to control a temperature of the enclosed volume in a temperature range extending from a first temperature that is below an ambient temperature and a second temperature that is greater than the ambient temperature.

11. The apparatus of claim 9 wherein the thermally-controlled chamber further comprises a thermally-conductive plate in thermal communication with the tubing.

12. The apparatus of claim 11 wherein the thermally-conductive plate is in communication with a cooling system.

13. The apparatus of claim 12 wherein the cooling system is a thermo-electric cooler.

14. The apparatus of claim 12 wherein the cooling system is a refrigerant system.

15. The apparatus of claim 11 wherein the thermally-conductive plate is in communication with a heating system.

16. The apparatus of claim 15 wherein the heating system comprises at least one resistive heating element disposed on at least one surface of the thermally-conductive plate.

17. The apparatus of claim 7 further comprising a temperature controller in communication with the thermally-controlled chamber and configured to control a temperature of the enclosed volume.

18. The apparatus of claim 17 wherein the temperature controller is configured to change the temperature of the enclosed volume between a minimum temperature at which the inlet check valve passes the flow of gas into the thermally-controlled chamber and a maximum temperature at which the outlet check valve passes the flow of gas out from the thermally-controlled chamber.
